(19) United States
(12) Patent Application Publication
(10) Pub. No.: US 2013/0061153 A1
(43) Pub. Date: Mar. 7, 2013

(54) System and Method for Inserting a Control System Into a Conference

(71) Applicants: Renato P. Simoes, Fortaleza-CE (BR); Brian Hillis, Centennial, CO (US)

(72) Inventors: Renato P. Simoes, Fortaleza-CE (BR); Brian Hillis, Centennial, CO (US)

(73) Assignee: AVAYA INC., BASKING RIDGE, NJ (US)

(21) Appl. No.: 13/226,563

(22) Filed: Sep. 7, 2011

(51) Int. Cl. G06F 3/01; G06F 15/16

(52) U.S. Cl. 715/753

(57) ABSTRACT

A conference, such as an audio or video conference, is controlled by inserting a control sequenced application into a communication stream. A command is received at the control sequenced application from a user interface to control an aspect of the conference. For example, the command may be to mute a participant of the conference. The command is sent to a media server, which implements that command. The control sequenced application is typically inserted in between the media server and a conferencing application. In addition, the control sequenced application can be dynamically inserted into the communication stream.

### TECHNICAL FIELD

The system and method relates to conferencing systems and in particular to control of conferencing systems.

### BACKGROUND

In today's distributed computing environment, the need to provide generic solutions for services such as audio and video conference is increasing. When custom solutions are designed to meet a specific need, many times there are a common set of services that need to be provided. Typically, the solution is to take the common services and add the custom services on top of the existing code.

One of the problems with this approach is that it is not always easy to separate the code for the common services from the code for the custom features. As the code base becomes larger, it becomes more difficult to make changes and maintain the code base. What is needed is a solution that allows developers an alternative that separates custom features from common services in a way that allows developers to easily drop in common services to enhance a custom solution.

### SUMMARY

The system and method are directed to solving these and other problems and disadvantages of the prior art. A conference, such as an audio or video conference, is controlled by inserting a control sequenced application into a communication stream. A command is received at the control sequenced application from a user interface to control an aspect of the conference. For example, the command may be to mute a participant of the conference. The command is sent to a media server, which implements the command. The control sequenced application is typically inserted in between the media server and a conferencing application. In addition, the control sequenced application can be dynamically inserted into the communication stream.

In one embodiment, the control sequenced application passes on messages between the conferencing application and the media server. In another embodiment, Session Initiation Protocol (SIP) is used.

Examples of various commands that can be implemented by the media server can include, but are not limited to, muting multiple participants, adding one or more participants to the conference, dropping one or more participants from the conference, sending a whisper prompt to one or more participants in the conference (i.e., a message that only goes to specific participants), forming a new conference with a subset of existing conference participants, and the like. The above examples can be implemented for an audio or a video conference.

Other embodiments include storing the status of the controlled aspect of the communication to a database so that the status can be read by a web server/user interface. This way the user can see the changes to the status in the user interface. For example, a status being viewed by a web browser.

### BRIEF DESCRIPTION OF THE DRAWINGS

In order to describe the manner in which other advantages and features of the disclosure can be obtained, a more particular description of the principles and the best mode briefly described below will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a block diagram of a first illustrative system for inserting a control sequenced application into a conferencing stream.

FIG. 2A is a flow diagram of a method for inserting a control sequenced application into a conferencing stream.

FIG. 2B is a flow diagram of a method for implementing aspects of a conference.

FIG. 3 is a flow diagram of a method for inserting a control sequenced application into a conferencing stream.

In the appended Figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The following description and associated Figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

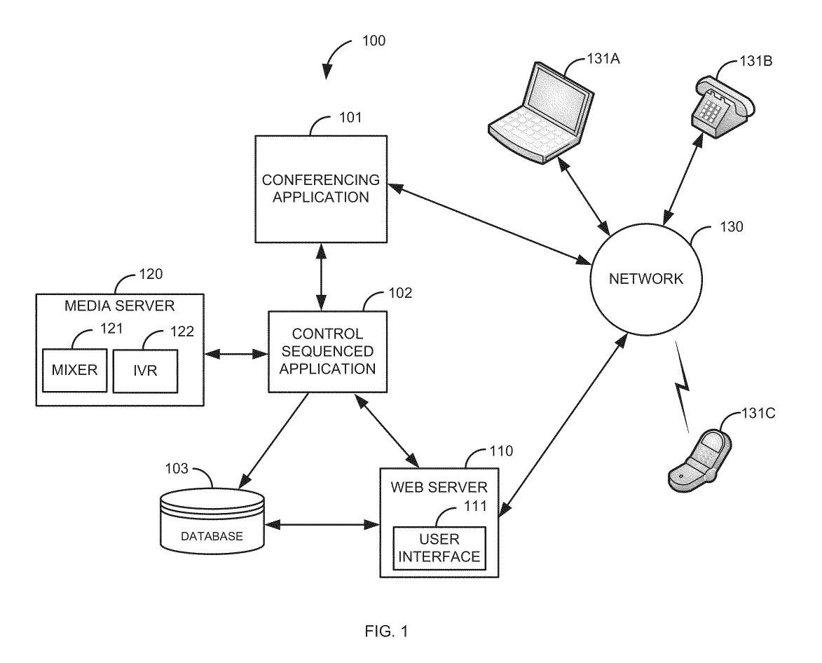

FIG. 1 is a block diagram of a first illustrative system 100 for inserting a control sequenced application 102 into a conferencing stream. The first illustrative system 100 comprises conferencing application 101, control sequenced application 102, database 103, web server 110, media server 120, network 130, and communication devices 131A-131C.

Conferencing application 101 can be any hardware/software that can be used to provide conferencing services. Conferencing application 101 can provide conferencing services for communication devices 131A-131C. Conferencing application 101 can provide some of these services by requesting them from media server 120. For example, conferencing application 101 can request the use of mixer 121 to set up an audio or video conference or request the use of Interactive Voice Response (IVR) system 122. In addition, conferencing application 101 can provide custom services, such as, but not limited to, emails, notifications using Hyper Text Transfer Protocol (HTTP), notifications using Instant Messaging (IM), providing recording services, and the like.

Control sequenced application 102 can be any hardware/software that can be inserted into the stream of a conference. For example, control sequenced application 102 can be a Back-to-Back User Agent (B2B UA) that can be inserted into a SIP stream between conferencing application 101 and media server 120.

Database 103 can be any type of database, such as a relational database, a file system, a directory service, an object oriented database, and the like. Database 103 is used to store information.

Web server 110 can be any type of web server that can provide web services. Web server 110 further comprises user interface 111. User interface 111 can be a web page that is provided to a browser (not shown) to administer control sequenced application 102. User interface 111 can be one or more web pages. Alternatively, web server 110/user interface 111 can comprise an application running on a device, such as a personal computer, that communicates with control sequenced application 102.

Media server 120 can be any device that can provide media services, such as a conference system, a server, a Private Branch Exchange (PBX), a communication system, and the like. Media server 120 can use a variety of protocols, such as SIP, H.232, Internet Protocol (IP), Media Server Markup Language (MSML), and the like. Media server 120 can be a generic media server that provides generic media services, such as video conferences, audio conferences, user authentication (via IVR 122), conference recording, and the like. Media server 120 is controlled by conferencing application 101 to provide services, such as setting up a video conference by dialing out to communication devices 131A-131C, having communication devices 131A-131C call into media server 120 to form an audio conference, providing notifications via IRV system 122, and the like.

Media server 120 further comprises mixer 121 and Interactive Voice Response (IVR) system 122. Mixer 121 can provide mixing services to set up an audio or video conference. IVR 122 can provide notifications, confirm conference numbers, authenticate users, direct callers to provide information (e.g., their name, title, etc.), and the like. Media server 120 can further comprise additional services. For example, media server 120 can also comprise a recorder to record an audio or video conference.

Network 130 can be any type of network, such as the Internet, a Local Area Network (LAN), a Wide Area Network (WAN), the Public Switched Telephone Network (PSTN), a cellular network, a corporate network, a combination of these, and the like. Network 130 can be a wired network, a wireless network, a fiber optic network, a combination of these, and/or the like. Network 130 can use a variety of protocols, such as Internet Protocol (IP), Session Initiation Protocol (SIP), H.323, Integrated Digital Services Network (ISDN), Asynchronous Transfer Mode, and the like. In FIG. 1, network 130 is shown to connect conferencing application 101, web server 110, and communication devices 131A-131C. However, other devices, such as media server 120, control sequenced application 102, and database 103, can also be connected to network 130. In addition, one of ordinary skill in the art would recognize that intermediary devices, such as routers, servers, hubs, firewalls, and the like, can be connected between or in conjunction with any of the devices shown in FIG. 1.

Communication devices 131A-131C can be any type of device that can communicate on network 130, such as a Personal Computer (PC), a telephone, a video phone, a cellular telephone, a Personal Digital Assistant (PDA), a recorder, and the like. In FIG. 1, there are three communication devices 131A-131C shown. However, in any given configuration, there can be more or less communication devices 131 as necessary to provide a specific communication service. For example, if a video conference only needed two participants, then the number of communication devices 131 necessary would be two. Likewise, if more than three participants are necessary to create a conference, the first illustrative system 100 would comprise additional communication devices 131.

A communication stream between conferencing application 101 and media server 120 is set up. The communication stream can be any type of communication path or communication between conferencing application 101 and media server 120. For example, the communication stream could be one or more HTTP messages (sent via user interface 111) that request media server 120 to call communication devices 131A-131B to set up a SIP audio conference between communication devices 131A-131C.

Control sequenced application 102 is inserted into the communication stream. Control sequenced application 102 can be inserted at various points of time during the communication. For example, control sequenced application 102 can be inserted prior to when conferencing application 101 communicates to media server 120. Moreover, control sequenced application 102 can be inserted dynamically after conferencing application 101 and media server 120 have started to communicate; this can occur even after a conference (established via media server 120) is in progress between communication devices 131A-131B. Control sequenced application 102 passes any messages sent from conferencing application 101 to media server 120. Likewise, control sequenced application 102 passes any messages from media server 120 to conferencing application 101. In essence, control sequenced application 102 just passes on any message that it receives that are intended for media server 120 or conferencing application 101.

In this illustrative example, user interface 111 is an administrative web page that a user can use to generate commands to control one or more aspects of a conference that are not currently provided in conferencing application 101. For instance, the user, via user interface 111 can control additional aspects of the conference that are not provided by conferencing application 101, such as muting a participant in the conference, adding a participant to the conference, dropping a participant from the conference, whispering a prompt to a participant in the conference, forming a new conference with a subset of existing conference participants, and the like.

As user interface 111 generates command(s) to control the aspect of the conference, the command(s) are sent to control sequenced application 102. The command(s) can use a variety of protocols, such as Hyper Text Transfer Protocol (HTTP), Internet Protocol, and the like. Control sequenced application 102 receives the command from user interface 111 to control the aspect of the conference. In response to receiving the command, control sequenced application 102 sends a message to media server 120 to control the aspect of the conference. In response, media server 120 controls the aspect of the conference.

To further illustrate how this works, consider the following example. Conference application 101 is a software application that provides a conferencing solution that is used to respond to emergencies when there is a major outage in a city's water system. Upon determining that there is a major outage in the city's water system, conferencing application 101 sends a command to set up an audio conference between communication devices 131A-131C. Communication devices 131A-131C are communication devices 131 for key managers in the water department. Media server 120 calls each of the communication devices 131A-131C to set up an audio conference via mixer 121. As the users of communication devices answer their communication devices 131A-131C, the audio conference is created between communication devices 131A-131C.

After the conference is set up, an administrator of the conference accesses web server 110 and user interface 111. The administrator of the conference wants to add a new participant to the conference and selects a menu in user interface 111 to add the new participant into the audio conference. The command to add the new participant to the conference is received from web server 110 at control sequenced application 102. In response to receiving the command to add the new participant to the conference, control sequenced application 102 sends a message to media server 120 to call the new participant so that the participant can be added to the audio conference.

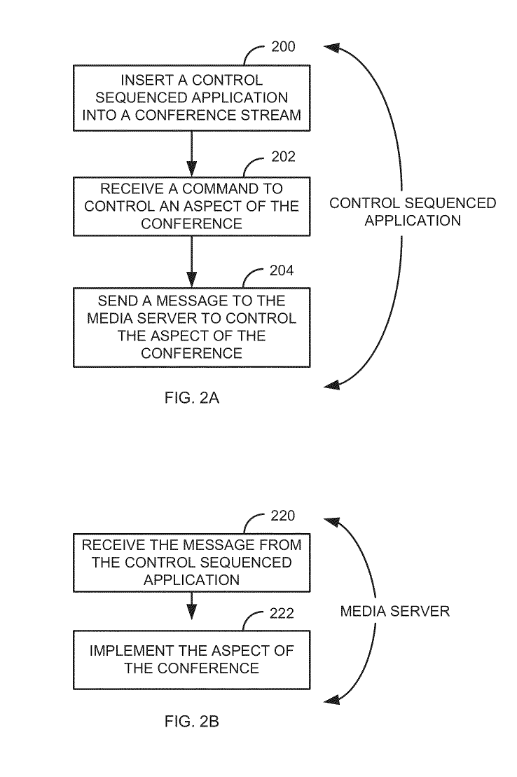

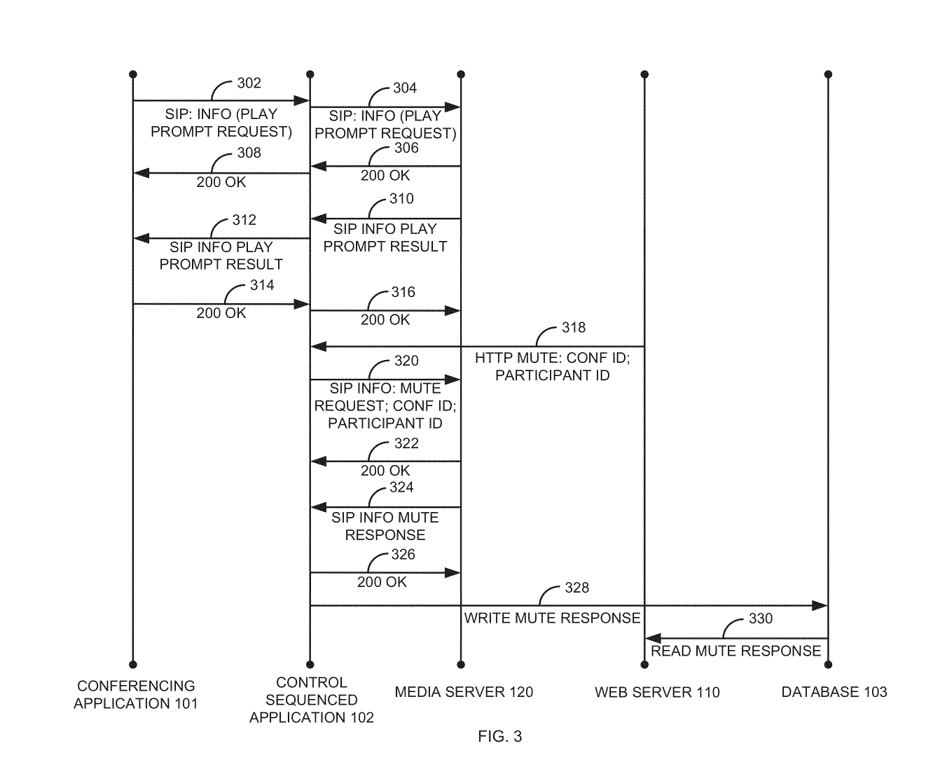

FIG. 2A is a flow diagram of a method for inserting a control sequenced application 102 into a conferencing stream. Illustratively, conferencing application 101, control sequenced application 102, database 103, media server 120, mixer 121, IVR 122, web server 110, user interface 111, and communication devices 131A-131C are stored-program-controlled entities, such as a computer or processor, which performs the methods of FIGS. 2A, 2B, and 3 and the processes described herein by executing program instructions stored in a tangible computer readable storage medium, such as a memory or disk.

The process described in FIG. 2A is shown from the perspective of control sequenced application 102. The process begins in step 200 when control sequenced application 102 is inserted into a conference stream. Control sequenced application 102 receives 202 a command (e.g., from web server 110 via user interface 111) to control an aspect of the conference. In response to receiving the command to control an aspect of the conference, control sequenced application 102 sends 204 a message to media server 120 to control the aspect of the conference.

FIG. 2B is a flow diagram of a method for implementing aspects of a conference. FIG. 2B is shown from the perspective of media server 120. After control sequenced application 102 sends the message in step 204, media server 120 receives 220 the message from control sequenced application 102. Media server 120 implements 222 the aspect of the conference. For example, if the command is to whisper a message to one of the conference participants, media server 120 will then whisper the message to the specific conference participant.

FIG. 3 is a flow diagram of a method for inserting a control sequenced application 102 into a conferencing stream. The method of FIG. 3 shows the control sequenced application 102 inserted into the communication stream. Once control sequenced application 102 is inserted into the communication stream, control sequenced application 102 transparently passes messages that are sent between conferencing application 101 and media server 120. This is illustrated in steps 302-316 where control sequenced application 102 just passes the messages through. The method of FIG. 3 is an illustrative example of using Session Initiation Protocol (SIP) to implement a particular embodiment.

The process begins in step 302 when conferencing application 101 sends a Session Initiation Protocol (SIP) INFO command to play a prompt request (e.g., via IRV 122). Control sequenced application 102 passes this message in step 304 to media server 120. Media server 120 sends a 200 OK in step 306 to control sequenced application 102. Control sequenced application 102 sends the 200 OK to conferencing application 101 in step 308.

Media server 120 sends a SIP INFO to play the prompt result in step 310. Control sequenced application 102 sends the SIP INFO play prompt result to conferencing application 101 in step 312. Conferencing application 101 sends a 200 OK to control sequenced application 102 in step 314. Control sequenced application 102 sends the 200 OK to media server 120 in step 316. So far, control sequenced application 102 just passes on any messages it received between conferencing application 101 and media server 120.

Web server 110 (via user interface 111) sends an HTTP MUTE request with a conference ID and a participant ID to control sequenced application 102 in step 318. In this example HTTP is used, however, one skilled in the art would recognize that a variety of different protocols can be used. The participant ID can be selected by a user such as the host of the conference (from user interface 111) based on which participant that the host of the conference wants to mute. The conference ID can be selected by the user or can be sent automatically by web server 110. Control sequenced application 102 sends 320 a SIP INFO Mute Request with the conference ID and participant ID to media server 120. Media server 120 sends 322 a 200 OK in step 322 to control sequenced application 102. Media server 120 sends a SIP INFO Mute Response in step 324 indicating that the participant has been muted. Control sequenced application 102 sends a 200 OK in step 326 to media server 120.

In addition, control sequenced application 102 writes that the mute response has been completed into database 103 in step 328. Web server 110 can poll at a later point in time to read 330 that the mute of the participant has been completed. Control sequenced application 102 writes the mute to database 103 so that web server 110 can be updated in regard to the completion of the mute request that was sent in step 318.

The above sequence is shown as an exemplary embodiment of a mute of a single participant. One of ordinary skill in the art would recognize that, by using like messaging, other features such as muting multiple participants, adding one or more participants to the conference, dropping one or more participants from the conference, sending a whisper prompt to one or more participants in the conference, forming a new conference with a subset of existing conference participants, and the like could be easily implemented within the described framework.

Herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Herein, the term “a,” “an,” or another entity refers to one or more of that entity. As such, the terms “a” (or “an”), “one or more” and “at least one” can be used interchangeably herein. It is also to be noted that the terms “comprising,” “including,” and “having” can be used interchangeably.

Of course, various changes and modifications to the illustrative embodiment described above will be apparent to those skilled in the art. These changes and modifications can be made without departing from the spirit and the scope of the system and method and without diminishing its attendant advantages. The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method for controlling a conference comprising:
inserting a control sequenced application into a communication stream;
receiving at the control sequenced application a command from a user interface to control an aspect of the conference, wherein control of the conference is accomplished by a media server; and
responsive to receiving the command from the user interface, sending a message to the media server to control the aspect of the conference.

2. The method of claim 1, wherein the communication stream is between a conferencing application and the media server.

3. The method of claim 2, wherein the control sequenced application passes on messages between the conferencing application and the media server.

4. The method of claim 3, wherein the passed on messages are Session Initiation Protocol (SIP) messages.

5. The method of claim 1, wherein the aspect of the conference is at least one of the following: to mute a participant in the conference, to add a participant to the conference, to drop a participant from the conference, to whisper a prompt to a participant in the conference, and to form a new conference with a subset of existing conference participants.

6. The method of claim 1, wherein the received command is an HTTP request from a web server and wherein the web server presents the user interface to an administrator of the conference.

7. The method of claim 1, further comprising the step of storing the aspect of the conference in a database.

8. The method of claim 1, wherein the conference is an audio or a video conference.

9. The method of claim 1, wherein the control sequenced application is dynamically inserted into the communication stream.

10. A system for controlling a conference comprising:
a control sequenced application configured to insert into a communication stream, receive a command from a user interface to control an aspect of the conference, responsive to receiving the command from the user interface, send a message to a media server to control the aspect of the conference; and
the media server configured to control the conference in response to receiving the message sent from the control sequenced application to control the aspect of the conference.

11. The system of claim 10, wherein the communication stream is between a conferencing application and the media server.

12. The system of claim 11, wherein the control sequenced application passes on messages between the conferencing application and the media server.

13. The system of claim 12, wherein the passed on messages are Session Initiation Protocol (SIP) messages.

14. The system of claim 10, wherein the aspect of the conference is at least one of the following: to mute a participant in the conference, to add a participant to the conference, to drop a participant from the conference, to whisper a prompt to a participant in the conference, and to form a new conference with a subset of existing conference participants.

15. The system of claim 10, wherein the received command is an HTTP request from a web server and wherein the web server presents the user interface to an administrator of the conference.

16. The system of claim 10, wherein the control sequenced application is further configured to store the aspect of the conference in a database.

17. The system of claim 10, wherein the conference is an audio or a video conference.

18. The system of claim 10, wherein the control sequenced application is dynamically inserted into the communication stream.

19. A computer readable medium having stored thereon instructions that cause a processor to execute a method, the method comprising:
instructions to insert a control sequenced application into a communication stream;
instructions to receive at the control sequenced application a command from a user interface to control an aspect of the conference, wherein control of the conference is accomplished by a media server; and
responsive to receiving the command from the user interface, instructions to send a message to the media server to control the aspect of the conference.
